(19) United States
(12) Patent Application Publication
(10) Pub. No.: US 2011/0295539 A1
(43) Pub. Date: Dec. 1, 2011

(54) METHOD AND APPARATUS FOR MEASURING INTRA-DIE TEMPERATURE

(75) Inventors: Chun Hsiung TSAI, Xinpu Township (TW); Chii-Ming WU, Taipei City (TW); De-Wei YU, Ping-tung (TW); Chien-Tai CHAN, Hsinchu City (TW)

(73) Assignee: TAIWAN SEMICONDUCTOR MANUFACTURING COMPANY, LTD., Hsinchu (TW)

(21) Appl. No.: 12/789,816

(22) Filed: May 28, 2010

(51) Int. Cl. G01J 5/00; G01K 15/00; G06F 19/00

(52) U.S. Cl. 702/99; 702/135

(57) ABSTRACT

A method for measuring the intra-die temperature of a wafer with a fast response time is described. The method includes providing a wafer in a thermal process chamber, radiating the wafer in a first predetermined radiation range to heat the wafer to a predetermined temperature range for a predetermined time, receiving the radiation reflected from a die area while the wafer is being heated and detecting reflected radiation having a second predetermined radiation range, and determining a temperature of the die area by a processor being responsive to the detected second predetermined radiation range.

### BACKGROUND

The disclosure relates generally to semiconductor processing, and more particularly to a method and apparatus for measuring the intra-die temperature of a wafer.

It is well known that any body having a temperature above absolute zero (−273.15° C.) emits electromagnetic radiation. This principle is illustrated in the graph of FIG. 1. According to FIG. 1, a perfect black body has a distribution of a spectral radiation intensity wherein the abscissa represents a wavelength (μm) and the ordinate represents a spectral radiance or radiation intensity (W_{λ}(Wcm⁻²μm⁻¹). As can be seen from the graph, the lower the temperature (K) of the object, the weaker the intensity of the ray radiated from the body and the greater the component of a longer wavelength. Conversely, the higher the temperature of the object, the stronger the intensity of the ray and the greater the component of a shorter wavelength radiated from the body.

There exists a correlation between the radiation of a body and its temperature. According to Wien's Law, the temperature of an object can be determined in a non-contact way by determining its radiation intensity. This radiation can be detected and therefore measured by an IR sensor. FIG. 2 illustrates the sensitivity curves of various sensors for the detection of infrared rays operative in a range of above the liquid nitrogen temperature, wherein the abscissa represents wavelength (μm) and the ordinate represents spectral sensitivities D_{λ}*(cm·Hz^{1/2}/w). It is apparent from FIG. 2 that InAs, PbS, and PbSe sensors have a higher sensitivity in a wavelength range of up to 4 μm, while an MCT (HgCdTe) sensor has a higher sensitivity in a wavelength range above 5 μm.

In semiconductor device fabrication, the characterization and measurement of the temperature variation across a wafer undergoing a thermal process in a thermal process chamber is critical for circuit performance and manufacturability. Thermally-introduced intra-die device variation resulting from process variations, such as non-uniform temperature applications can affect device performance and lead to low yields and/or device failures. The detrimental impact of intra-die device variation has begun to assume a more prominent position as the feature size has exceeded half-micron dimensions and the wafer size has grown to 200 mm. Current thermal process chambers such as rapid thermal processor (RTP) chambers employ two or more pyrometers at various locations underneath the backside of the wafer to measure the temperature variation across the wafer. Pyrometers detect an object's surface temperature in a non-contact manner by measuring the temperature of the electromagnetic radiation (infrared or visible) emitted from the object. Although pyrometers measure the temperature across a wafer or the temperature variation from die to die, there is currently no method or apparatus available to measure the temperature change across the die or to measure that temperature variation with a fast response time during a spike anneal event.

For these reasons and other reasons that will become apparent upon reading the following detailed description, there is a need for a method and apparatus to measure the intra-die or die-level temperatures of wafers.

### BRIEF DESCRIPTION OF DRAWINGS

The features, aspects, and advantages of the disclosure will become more fully apparent from the following detailed description, appended claims, and accompanying drawings in which:

FIG. 1 is a graph illustrating a distribution of a spectral radiation intensity of a perfect black body at various temperatures.

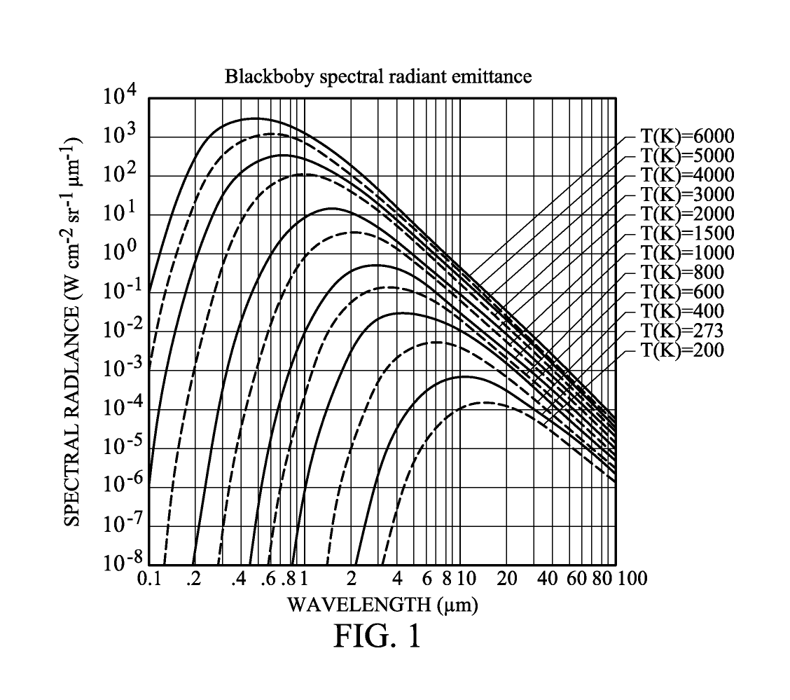

FIG. 2 is a graph showing sensitivity curves of various sensors operative in a range of temperatures.

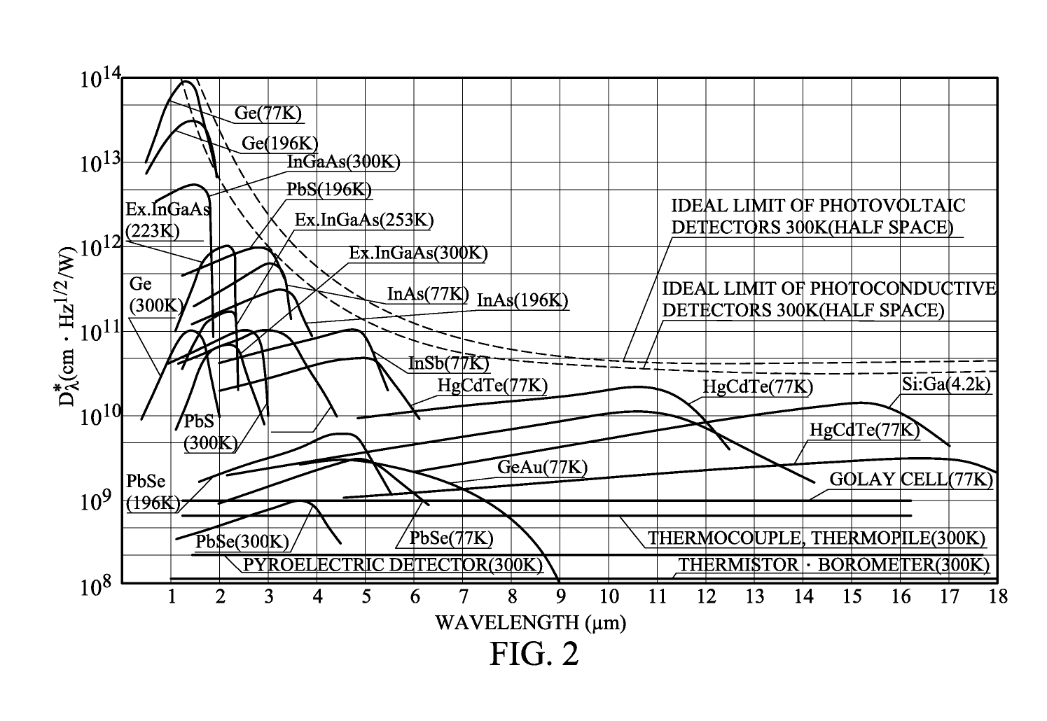

FIG. 3 is a schematic drawing illustrating a rapid thermal process chamber, according to one embodiment of the present disclosure.

### DETAILED DESCRIPTION

In the following description, numerous specific details are set forth to provide a thorough understanding of embodiments of the present disclosure. However, one having an ordinary skill in the art will recognize that embodiments of the disclosure can be practiced without these specific details. In some instances, well-known structures and processes have not been described in detail to avoid unnecessarily obscuring embodiments of the present disclosure.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. It should be appreciated that the following figures are not drawn to scale; rather, these figures are merely intended for illustration.

The present disclosure is embodied in a method and apparatus for directly measuring, in a non-contact manner the temperature of a device under test (DUT), such as a wafer while it is being thermally processed. The method and apparatus include incorporating one or more infrared detectors in a thermal process oven. The one or more infrared detectors allow the direct measurement of the temperature of the die or an area of the die during thermal processing of the wafer by sensing the infrared radiation emitted off the wafer in a certain radiation range.

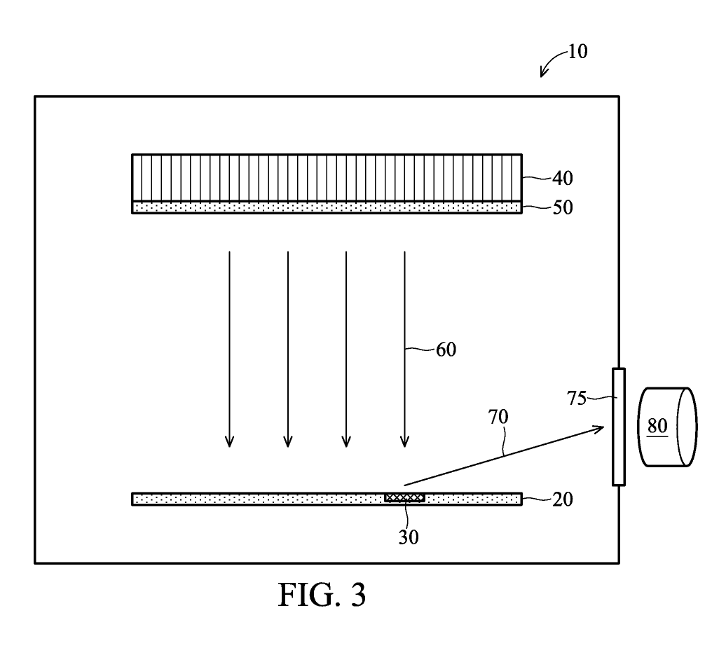

FIG. 3 is a schematic drawing illustrating a thermal process chamber 10 having a radiation source 40, a transmissive plate 50, a wafer 20, and an infrared radiation detector or radiation detector 80, according to one embodiment of the present disclosure. The heating chamber or thermal process chamber 10 includes a rapid thermal processor (RTP) chamber, according to one embodiment of the present disclosure. RTP chambers typically process a single wafer at a time with a radiant heat source and cooling source and anneal the wafer by using an extremely fast ramp and short dwell time, such as from about 0.5 seconds to about 10 seconds at a target temperature (typically 1,010° C.). Though one embodiment of the present disclosure includes the RTP chamber, the teachings of the present disclosure can be used in conjunction with any type of chambers used in thermal processing of electronic devices or packages. For the purposes of the present disclosure, the term “chamber” indicates any enclosure in which heat or light energy is applied to a wafer, semiconductor device, electronic package, or any component of an electronic package to heat, irradiate, dry, or cure the wafer, semiconductor device, electronic package, or any component of the electronic package.

The radiation source 40 of the thermal process chamber 10 directs thermal energy or incident infrared radiation 60 to a DUT to heat the DUT. The DUT may be a semiconductor wafer, a semiconductor chip, multiple such semiconductor chips, a circuit board, or virtually any other device. In one embodiment, the DUT is a wafer 20, as shown in FIG. 3. Tungsten halogen lamps may be used as the source of the radiation source 40, according to one embodiment of the present disclosure. It is understood by those skilled in the art that other sources of radiation may also be used. According to some embodiments, the tungsten halogen lamps comprise multiple lamps ranging from 20 lamps to over 409 lamps and are organized into zones ranging from 2 to 15 zones. Tungsten halogen lamps emit infrared radiation in the short wavelength band corresponding to a wavelength range from about 0.35 μm to about 3 μm. This radiation is transmitted to the DUT through the transmissive plate 50, which acts as a protective IR window for radiation source 40 and may be made of quartz or other material for selective IR range transmission.

The radiation detector 80 detects the emitted or reflected radiation 70 from the wafer 20 and therefore does not need to directly contact the DUT to achieve an accurate temperature reading. The detector diode is typically a semiconductor comprised of a photovoltaic material having a property of generating electrical energy, such as a current when exposed to light, such as infrared radiation. The electrical energy may then be converted to a temperature measurement, for example.

The radiation detector 80 may be of the photoconductive type and comprise lead sulfide (PbS) and lead selenide (PbSe) detectors operating in the wavelength region from about 1 μm to about 6 μm. Both PbS and PbSe detectors are chemically deposited, thin film, photoconductive IR detectors that require a bias voltage to measure resistance drop when exposed to IR radiation. The radiation detector 80 may be one having 2D arrays. Virtually all IR detectors vary with the temperature. In one embodiment of the disclosure, detector 80 operates within the temperature range from about 600° C. to about 1,300° C., has a spatial resolution of less than 500 μm, and has a response spectrum from about 3 μm to about 6 μm. One of ordinary skill in the art understands that detectors come in various minimum spot sizes in order to match spot size to die size. Also, one skilled in the art understands that the detector is chosen for its specific sensitivity and range of wavelengths to which it is responsive (along with necessary amplification requirements for signal generated). An example of a commercially available photoconductive type infrared detector suitable for one embodiment of the present disclosure is the IEEMAP-2DV™, which is commercially available from Wilmington Infrared Technologies, Inc.

The radiation detector 80 is mounted in a location in or on the thermal processing chamber 10 at a location close to, or slightly above the wafer 20 or the DUT. The radiation detector 80 is mounted in such a location from the thermal processing chamber 10 so as to be able to receive the reflected radiation 70 from wafer 20 or the DUT. In one embodiment, the radiation detector 80 is mounted outside a viewport window 75 of the RTP chamber 10. It should be understood that the radiation detector 80 may be located at various other locations onboard or around the heat chamber to sense thermal energy.

In operation, according to one embodiment the wafer 20 is heated by selectively absorbing incident radiation 60 from the tungsten halogen lamps 40, which produces short-wavelength radiation ranging from about 0.35 μm to about 3 μm. In this manner, the thermal process chamber 10 transfers energy between radiation source 40 and wafer 20 with the quartz window or transmissive plate 50 passing the radiation thereto. Following an initial heating, the wafer 20 is then spike annealed and heated at a target temperature of about 1,010° C. for a short duration of time. In one embodiment, the wafer 20 is heated at a temperature from about 650° C. to about 1010° C. for about 0.5 seconds to about 4 seconds. In another embodiment, the wafer 20 is heated at a temperature from about 650° C. to about 1010° C. for about 5 seconds to about 10 seconds. During the spike anneal heating, the wafer 20 will irradiate the full infrared spectrum, depending on the temperature the wafer 20 is heated at. Infrared radiation detector 80 is focused on a certain area of die 30 and configured to receive a certain radiation wavelength. In one embodiment, this radiation wavelength ranges from about 3 μm to about 6 μm. In another embodiment, this radiation wavelength ranges from about 2 μm to about 5 μm. Infrared detector 80 receives the heat energy or reflected radiation 70 radiated from the wafer 20 and converts that heat energy passively to an electrical signal, which is then converted through a signal processor (not shown) to a temperature measurement corresponding with the characteristics of the infrared detector 80.

Short wavelength band corresponding to a wavelength range of from 0.35 μm to about 3 μm, middle wavelength band corresponding to a wavelength range of from 3 μm to 6 μm, and perhaps the long wavelength band of from 8 μm to 12 μm are all incident on the infrared detector 80. However, by focusing the infrared detector 80 on a certain area of die 30 and operable to sense a certain infrared radiation in the middle wavelength band corresponding to the range from 3 μm to 6 μm, radiation wavelength in the short wavelength band (e.g., from 0.35 μm to about 3 μm) coming from the radiation source 40 is not detected. As such, the temperature of the die area is measured and not the temperature of the surrounding components (e.g., radiation source 40) in the heat chamber 10. To increase infrared detection efficiency, the detector 80 should be cooled during temperature ramp up times.

In the preceding detailed description, the present disclosure is described with reference to specific exemplary embodiments thereof. It will, however, be evident that various modifications, structures, processes, and changes may be made thereto without departing from the broader spirit and scope of the present disclosure. The specification and drawings are to be regarded as illustrative and not restrictive. It is understood that embodiments of the present disclosure are capable of using various other combinations and environments and are capable of changes or modifications within the scope of the invention as expressed herein. For example, although the disclosure is particularly described for the detection of the middle wavelength band corresponding to a wavelength range of from about 3 μm to and about 6 μm, teachings of the present disclosure is equally applicable to the detection of radiation in other wavelength regimes, such as the LWIR and SWIR.

What is claimed is:

1. An apparatus for providing non-contact temperature measurement of a device under test (DUV), comprising:
a radiation source for transmitting incident radiation to the DUV to heat the DUV to a predetermined temperature range for a predetermined time, the incident radiation having a first predetermined radiation range;
a radiation detector for receiving radiation reflected from the DUV while the DUV is being heated, wherein the radiation detector is configured to detect a second predetermined radiation range; and
a processor coupled to the radiation detector, the processor being responsive to the second predetermined radiation range so as to generate a calibrated temperature signal for the DUV.

2. The apparatus of claim 1, wherein the DUT comprises at least one of a semiconductor wafer or a semiconductor die.

3. The apparatus of claim 1, wherein the radiation source is a tungsten halogen lamp heat source.

4. The apparatus of claim 1, wherein the first predetermined radiation range is between about 0.35 μm and about 3 μm.

5. The apparatus of claim 1, wherein the second predetermined radiation range is between about 3 μm and about 6 μm.

6. The apparatus of claim 1, wherein the radiation detector is an infrared sensor with 2D arrays.

7. The apparatus of claim 1, wherein the DUT is heated at a predetermined temperature range of between about 650° C. and about 1010° C. for a predetermined time of between about 0.5 seconds and about 4 seconds.

8. A thermal process chamber for measuring an intra-die temperature of a wafer with a fast response time, the chamber comprising:
a radiation source for transmitting incident radiation to the wafer to heat the wafer to a predetermined temperature range for a predetermined time, the incident radiation having a first predetermined radiation range;
a radiation detector for receiving radiation reflected from a die area while the wafer is being heated, wherein the radiation detector is configured to detect a second predetermined radiation range; and
a processor coupled to the radiation detector, the processor being responsive to the second predetermined radiation range so as to generate a calibrated temperature signal for the die area.

9. The thermal process chamber of claim 8, wherein the chamber is a rapid thermal processor (RTP) chamber.

10. The thermal process chamber of claim 9, wherein the radiation detector is positioned outside a viewport window of the RTP chamber.

11. The thermal process chamber of claim 8, wherein the radiation detector is an infrared sensor with 2D arrays.

12. The thermal process chamber of claim 8, wherein the radiation source is a tungsten halogen lamp heat source.

13. The thermal process chamber of claim 8, further comprising a transmissive plate disposed in front of the radiation source to pass selective radiation therethrough.

14. The thermal process chamber of claim 8, wherein the first predetermined radiation range is between about 0.35 μm and about 3 μm.

15. The thermal process chamber of claim 8, wherein the second predetermined radiation range is between about 3 μm and about 6 μm.

16. The thermal process chamber of claim 8, wherein the wafer is heated at a predetermined temperature range of between about 650° C. and about 1010° C. for a predetermined time of between about 0.5 seconds and about 4 seconds.

17. A method for measuring an intra-die temperature of a wafer with a fast response time, comprising:
providing a wafer in a thermal process chamber;
radiating the wafer in a first predetermined radiation range to heat the wafer to a predetermined temperature range for a predetermined time;
receiving radiation reflected from a die area while the wafer is being heated and detecting reflected radiation having a second predetermined radiation range; and
determining a temperature of the die area by a processor being responsive to the received radiation with the second predetermined radiation range.

18. The method of claim 17, wherein the first predetermined radiation range is between about 0.35 μm and about 3 μm.

19. The method of claim 17, wherein the second predetermined radiation range is between about 3 μm and about 6 μm.

20. The method of claim 17, wherein the object is heated at a predetermined temperature range of between about 650° C. and about 1010° C. for a predetermined time of between about 0.5 seconds and about 4 seconds.
